(19) United States
(12) Patent Application Publication
(10) Pub. No.: US 2025/0088322 A1
(43) Pub. Date: Mar. 13, 2025

(54) APPARATUSES AND WIRELESS COMMUNICATION METHODS OF RESOURCE ALLOCATION

(71) Applicant: GUANGDONG OPPO MOBILE TELECOMMUNICATIONS CORP., LTD., Dongguan (CN)

(72) Inventor: Wenfeng ZHANG, Dongguan (CN)

(21) Appl. No.: 18/958,130

(22) Filed: Nov. 25, 2024

Related U.S. Application Data
(63) Continuation of application No. PCT/CN2023/122819, filed on Sep. 28, 2023.
Application No. PCT/CN2023/122819 is a continuation of application No. 63/412,284, filed on Sep. 30, 2022.

(51) Int. Cl. H04L 5/00; H04W 72/0453; H04W 72/23

(52) U.S. Cl. CPC H04L 5/0044; H04L 5/001; H04W 72/0453; H04W 72/23

(57) ABSTRACT

A wireless communication method of resource allocation performed by a user equipment (UE) includes being configured with a blocking band in frequency domain on an orthogonal frequency division multiplexing (OFDM) symbol and determining whether resource blocks (RBs) in the blocking band are available for a physical downlink shared channel (PDSCH) allocation through a signaling.

### CROSS-REFERENCE TO RELATED APPLICATION(S)

This application is continuation of International Application No. PCT/CN2023/122819 filed on Sep. 28, 2023, which claims the benefit of priority to U.S. Provisional Application No. 63/412,284 filed on Sep. 30, 2022. The contents of both applications are hereby incorporated by reference in their entirety.

### BACKGROUND

There is currently standardization activity in 3rd generation partnership project (3GPP) work studying method for frequency-domain resource allocation around duplexing subband. However, in current technologies and/or standardizations, aspects for solutions to indicate frequency-domain resource allocation in a symbol with a duplexing subband are open issues.

Therefore, there is a need for apparatuses and wireless communication methods of resource allocation such as solutions to indicate frequency-domain resource allocation in a symbol with a duplexing subband, which can solve issues in the prior art and other issues.

### SUMMARY

The present disclosure relates to the field of communication systems, and more particularly, to wireless communication methods of resource allocation, user equipment (UE) and a base station.

In a first aspect of the present disclosure, a wireless communication method of resource allocation performed by a user equipment (UE) includes being configured with a blocking band in frequency domain on an orthogonal frequency division multiplexing (OFDM) symbol and determining whether resource blocks (RBs) in the blocking band are available for a physical downlink shared channel (PDSCH) allocation through a signaling.

In a second aspect of the present disclosure, a wireless communication method of resource allocation performed by a base station includes configuring, to a user equipment (UE), a blocking band in frequency domain on an orthogonal frequency division multiplexing (OFDM) symbol and indicating, to the UE, whether resource blocks (RBs) in the blocking band are available for a physical downlink shared channel (PDSCH) allocation through a signaling.

In a third aspect of the present disclosure, a UE includes a receiver configured to receive a configuration of a blocking band in frequency domain on an orthogonal frequency division multiplexing (OFDM) symbol and a determiner configured to determine whether resource blocks (RBs) in the blocking band are available for a physical downlink shared channel (PDSCH) allocation through a signaling.

In a fourth aspect of the present disclosure, a base station includes an allocator configured to configure, to a user equipment (UE), a blocking band in frequency domain on an orthogonal frequency division multiplexing (OFDM) symbol and an indicator configured to indicate, to the UE, whether resource blocks (RBs) in the blocking band are available for a physical downlink shared channel (PDSCH) allocation through a signaling.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipment (UE) and a base station of communication in a communication network system according to an embodiment of the present disclosure.

FIG. 2 is a block diagram of a UE according to an embodiment of the present disclosure.

FIG. 3 is a block diagram of a UE according to an embodiment of the present disclosure.

FIG. 4 is a flowchart illustrating a wireless communication method of resource allocation performed by a UE according to an embodiment of the present disclosure.

FIG. 5 is a block diagram of a base station according to an embodiment of the present disclosure.

FIG. 6 is a block diagram of a base station according to an embodiment of the present disclosure.

FIG. 7 is a flowchart illustrating a wireless communication method of resource allocation performed by a base station according to an embodiment of the present disclosure.

FIG. 8 is a schematic diagram illustrating an uplink (UL) subband and downlink (DL) blocking band in a DL symbol configured to implement some embodiments presented herein.

FIG. 9 is a schematic diagram illustrating a DL resource allocation with a DL blocking band unavailable for DL configured to implement some embodiments presented herein.

FIG. 10 is a schematic diagram illustrating a DL resource allocation with a DL blocking band either available or unavailable for DL configured to implement some embodiments presented hercin.

FIG. 11 is a schematic diagram illustrating indication of whether a DL blocking subband takes effect configured to implement some embodiments presented herein.

FIG. 12 is a block diagram of a computing device according to an embodiment of the present disclosure.

FIG. 13 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In 3rd generation partnership project (3GPP) new radio (NR), which is a 5th generation (5G) orthogonal frequency division multiplexing (OFDM)-based radio access technology (RAT), radio resources are defined on a 2-dimensional time-frequency resource plain for downlink and uplink. The downlink is a transmission direction from a base station (BS, or so-called gNB in 3GPP NR) to a user equipments (UE), and the uplink is a transmission direction from the UE to the base station. On a resource plain, a minimum resource unit called “resource element” (RE) is defined corresponding to one subcarrier in frequency domain and one OFDM symbol in time domain. In frequency domain, twelve consecutive subcarriers construct one resource block (RB), which serves as the minimum resource allocation granularity in frequency domain. In time domain, one OFDM symbol is the minimum resource allocation granularity. Seven consecutive OFDM symbols construct one time slot.

As of 3GPP NR Release 17, one OFDM symbol can be configured by radio resource control (RRC) layer signaling to be used by a UE as one of {downlink symbol, uplink symbol, flexible symbol}, wherein:
Downlink symbol can be used, from UE perspective, for downlink reception only. It cannot be used by the UE for uplink transmission.
Uplink symbol can be used, from UE perspective, for uplink transmission only. It cannot be used by the UE for downlink reception.
Flexible symbol can be used, from UE perspective, for either downlink reception or uplink transmission, depending on the further dynamic assignment in real-time base station scheduling. However, a UE would not perform both downlink reception and uplink transmission in the same OFDM symbol in a (time division duplex) TDD spectrum. In other words, NR UE is not required to support full-duplex mode (contrary to half-duplex) in the TDD spectrum.

As a tradition in the TDD spectrum, when a UE switches its radio frequency (RF) unit from downlink reception to uplink transmission, there is some guard time around the switch instance. In contrast, no guard time is required when the RF is switched from uplink to downlink.

As of NR Release 17, there are two levels of TDD uplink/downlink (UL/DL) configurations:
Cell-specific TDD UL/DL configuration by an RRC information clement (IE) “tdd-UL-DL-ConfigurationCommon”: it defines a UE-common periodic pattern for TDD uplink/downlink allocation for OFDM symbols in time domain, where each periodic pattern contains a number (L_{D}) of consecutive downlink symbols, followed by a number (L_{F}) of consecutive flexible symbols, then followed by a number (L_{U}) of consecutive uplink symbols. Support of “tdd-UL-DL-ConfigurationCommon” is mandatory for TDD UE.
UE-specific TDD UL/DL configuration by the RRC information clement (IE) “tdd-UL-DL-ConfigurationDedicated”: it re-defines each of flexible symbol in “tdd-UL-DL-ConfigurationCommon” to be one kind from {downlink symbol, uplink symbol, flexible symbol}, but it cannot change the downlink symbol or uplink symbol in “tdd-UL-DL-ConfigurationCommon” to flexible symbol or the symbol with opposite direction. Support of “tdd-UL-DL-ConfigurationDedicated” is an optional UE capability.

When it comes to NR Release-18, one duplex enhancement is proposed in 3GPP to support in TDD carrier a full-duplex operation on a base station side while the half-duplex operation is maintained on a user equipment side. For examples, the base station may transmit downlink signal to one UE and receive uplink signal from another UE at the same time in a TDD carrier, while no single UE performs simultaneous downlink reception and uplink transmission. Here “simultaneous” means “in the same OFDM symbol”. Further, because the base station needs to serve the legacy UE which may not support “tdd-UL-DL-ConfigurationDedicated”, and the number of flexible symbols configured for the legacy UE could be restricted, the number of flexible symbols in “tdd-UL-DL-ConfigurationCommon” may be limited in a real-world deployment. Therefore, it is not sufficient to rely on legacy flexible symbol to provide full duplex operation on base station side.

It is proposed in 3GPP to reallocate some resources in downlink symbol(s) for uplink use, and/or to reallocate some resources in uplink symbol(s) for downlink usc. Such resource reallocation is proposed to be fulfilled by “duplexing subband”, which is defined as a set of consecutive resource blocks (RBs) in the frequency domain that are ensured by a base station scheduling to have a same duplexing direction (i.e., the transmission direction configured for the resources within the duplexing subband) selected between downlink and uplink. Each duplexing subband is associated with a subband bandwidth in frequency domain and a time-span in time domain.

For the purposes of downlink reception scheduling and uplink transmission grant in 5G-NR, the base station needs to inform a UE, by a scheduling/grant signling, of frequency-domain resources for the UE to use for either reception or transmission. In 3GPP NR, both downlink frequency domain resource allocation (FDRA) and uplink FDRA have three types:
Type-0 FDRA only: In FDRA of type 0, resource block assignment information in FDRA includes a bitmap indicating resource block groups (RBGs) that are allocated to the scheduled UE, and each bit in the bitmap represents a RBG containing P consecutive resource blocks (RB), where P is in form of 2^{k} (1≤k≤4) and derivable depending on radio resource control (RRC) layer configurations and frequency bandwidth of a corresponding bandwidth part (BWP). The number of bits in the bitmap is determined as

$${N}_{FDRA}^{type 0} = ⌈ \frac{{N}_{BWP}^{size} + ( {N}_{BWP}^{start} mod P )}{P} ⌉ ,$$

where N_{BWP}^{size} and N_{BWP}^{start} are respectively the size and starting position of the BWP, both in unit of RB.
Type-1 FDRA only: In FDRA type 1, the resource block assignment information in FDRA indicates to a scheduled UE, a set of contiguously allocated resource blocks within an active BWP of size N_{BWP}^{size}. The RB allocation can start at any single RB and contain any number of RBs subject to a BWP boundary. 3GPP NR has designed a specific resource indication value (RIV) coding scheme to indicate the selection of any number of contiguous RBs starting at any RB location within N_{BWP}^{size} RBs, with the bit length of such indication equal to

$${N}_{FDRA}^{type 1} = ⌈ {log}_{2} ( \frac{{N}_{BWP}^{size} \cdot ( {N}_{BWP}^{size} + 1 )}{2} ) ⌉ .$$

The corresponding RIV encoding is specified as following: A downlink type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by:

if (L_{RBs} − 1) ≤ └N_{BWP}^{size}/2┘ then
RIV = N_{BWP}^{size} · (L_{RBs} − 1) + RBₛₜₐᵣₜ
else
RIV = N_{BWP}^{size} · (N_{BWP}^{size} − L_{RBs} + 1) + (N_{BWP}^{size} − 1 − RBₛₜₐᵣₜ)
where 1 ≤ L_{RBs} ≤ B_{BWP}^{size} − RBₛₜₐᵣₜ.

Dynamic switch between Type-0 FDRA and Type-1 FDRA: The FDRA field of the signaling has bit size of max(N_{FDRA}^{type0}, N_{FDRA}^{type1})+1, where the first most-significant-bit (MSB) is used to indicate whether the remaining field bits are used to indicate type-0 FDRA or type-1 FDRA.
Each of above FDRA schemes applies to one BWP on one frequency carrier.

When a UE is configured with a duplexing subband for uplink within an OFDM downlink symbol, it is desirable for the base station scheduling to retain the ability to schedule the downlink reception in the OFDM symbol in case the base station does not grant the UE with any uplink transmission in the duplexing subband over the OFDM symbol. In other words, if the OFDM symbol is not used for uplink transmission by the UE, it can still be available for downlink reception by the UE.

Some embodiments of the present disclosure provide apparatuses and wireless communication methods of resource allocation such as solutions to indicate frequency-domain resource allocation in a symbol with a duplexing subband where the transmission direction of the frequency-domain resource allocation is opposite to the transmission direction of the duplexing subband. For examples, some embodiments of the present disclosure have a specific application to the 3GPP NR system. Further, for examples, some embodiments of the present disclosure provide a new signaling method in scheduling downlink reception for a UE over an OFDM downlink symbol in which the UE is configured with a duplexing subband of uplink.

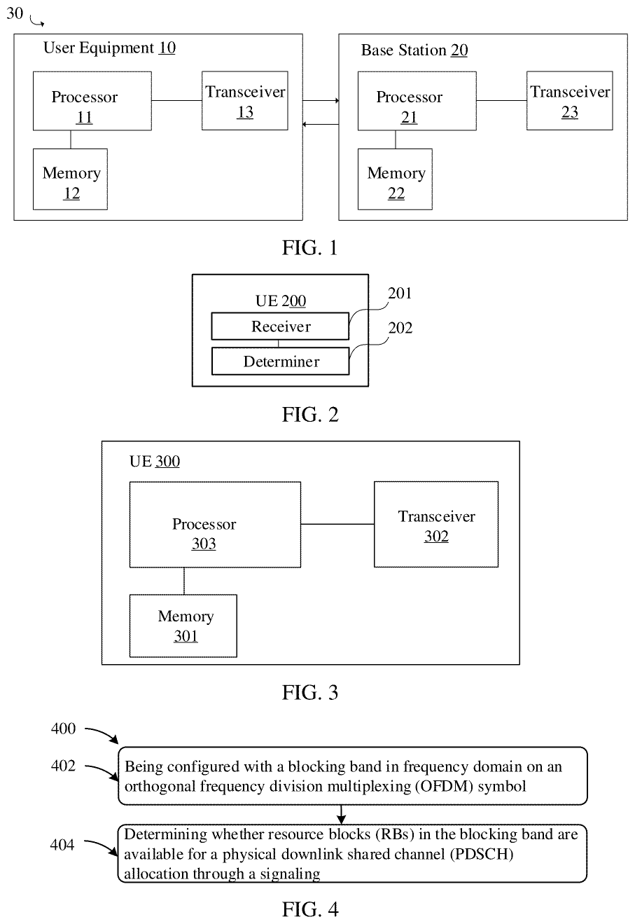

FIG. 1 illustrates that, in some embodiments, a user equipment (UE) 10 and a base station 20 (e.g., gNB) of communication in a communication network system 30 (e.g., an NR system) according to an embodiment of the present disclosure are provided. The communication network system 30 includes the UE 10 and the base station 20. The UE 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured with a blocking band in frequency domain on an orthogonal frequency division multiplexing (OFDM) symbol, and the processor 11 is configured to determine whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured. In some examples, the signaling may be a downlink control information (DCI). In details, in some examples, the processor 11 is configured with a blocking band in frequency domain on an orthogonal frequency division multiplexing (OFDM) symbol through a radio resource control (RRC) signaling. In some examples, the processor 11 is configured to determine whether resource blocks (RBs) in the blocking band are available for a physical downlink shared channel (PDSCH) allocation through a DCI. In some examples, the blocking band may refer to resource blocks (RBs) in frequency domain, and the RBs can be indicated whether to be available to the scheduled PDSCH resource allocation. In some examples, the blocking band may refer to a downlink (DL) blocking band. For example, in order to support an uplink (UL) subband in a DL OFDM symbol, a set of contiguous RBs containing the UL subband as well as the guard bands may be potentially reserved as not available to DL resource allocation. Some embodiments name this set of contiguous RBs as downlink blocking band and address issues when a PDSCH is scheduled in an OFDM symbol in which a downlink block band is configured and other issues.

In some embodiments, the processor 21 may configure, to the UE 10, a blocking band in frequency domain on an orthogonal frequency division multiplexing (OFDM) symbol, and the processor 21 may indicate, to the UE 10, whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured.

FIG. 2 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a receiver 201 configured to receive a configuration of a blocking band in frequency domain on an orthogonal frequency division multiplexing (OFDM) symbol and a determiner 202 configured to determine whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured. Further, the UE 200 is configured to perform at least one of wireless communication methods of resource allocation in some embodiments described herein.

FIG. 3 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art. Further, the UE 300 is configured to perform at least one of wireless communication methods of resource allocation in some embodiments described herein.

In some embodiments, the processor 303 is configured with a blocking band in frequency domain on an orthogonal frequency division multiplexing (OFDM) symbol, and the processor 303 is configured to determine whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured.

FIG. 4 is an example of a wireless communication method 400 of resource allocation performed by a UE according to an embodiment of the present disclosure. The wireless communication method 400 of resource allocation performed by a UE is configured to implement some embodiments of the disclosure. Some embodiments of the disclosure may be implemented into the wireless communication method 400 of resource allocation performed by a UE using any suitably configured hardware and/or software. In some embodiments, the wireless communication method 400 of resource allocation performed by a UE includes: an operation 402, being configured with a blocking band in frequency domain on an orthogonal frequency division multiplexing (OFDM) symbol, and an operation 404, determining whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured.

In some embodiments, the RBs in the blocking band are not available for the PDSCH allocation. In some embodiments, a bit size of a frequency domain resource allocation (FDRA) field in the signaling is determined by not including the RBs in the blocking band into the PDSCH allocation. In some embodiments, the bit size of the FDRA field in the signaling is determined based on a size of the blocking band and a size of a bandwidth part (BWP). In some embodiments, the bit size of FDRA field in the signaling is determined based on a FDRA of type 0, a FDRA of type 1, and/or a dynamic switch between the FDRA of type 0 and the FDRA of type 1. In some embodiments, the bit size of the FDRA field in the signaling is determined by at least one of the followings:

$${N}_{FDRA , new}^{type 0} = ⌈ \frac{{N}_{BWP}^{size} - {N}_{BLCK}^{size} + ( {N}_{BWP}^{start} mod P )}{P} ⌉$$

for the FDRA of type 0;

$${N}_{FDRA , new}^{type 1} = ⌈ {log}_{2} ( \frac{( {N}_{BWP}^{size} - {N}_{BLCK}^{size} ) \cdot ( {N}_{BWP}^{size} - {N}_{BLCK}^{size} + 1 )}{2} ) ⌉$$

for the FDRA of type 1; or max(N_{FDRA,new}^{type0}, N_{FDRA,new}^{type1})+1 for a dynamic switch between the FDRA of type 0 and the FDRA of type 1, where N_{FDRA,new}^{type0} refers to a new bit size for the FDRA of type 0, N_{BWP}^{size} refers to the size of the BWP, N_{BLCK}^{size} refers to the size of the blocking band, N_{BWP}^{start} refers to a starting position of the BWP, and N_{FDRA,new}^{type1} refers to a new bit field size for the FDRA of type 1.

In some embodiments, bit size determinations apply if and only if at least one of the following conditions is met: N_{FDRA,new}^{type0}<N_{FDRA}^{type0} for the FDRA of type 0; N_{FDRA,new}^{type1}<N_{FDRA}^{type1} for the FDRA of type 1; or max(N_{FDRA,new}^{type0}, N_{FDRA,new}^{type1})<max(N_{FDRA}^{type0}, N_{FDRA}^{type1}) for the dynamic switch between the FDRA of type 0 and the FDRA of type 1, where N_{FDRA,new}^{type0} refers to a new bit size for the FDRA of type 0, N_{FDRA}^{type0} refers to a bit size for the FDRA of type 0, N_{FDRA,new}^{type1} refers to a new bit field size for the FDRA of type 1, and N_{FDRA}^{type1} refers to a bit size for the FDRA of type 1.

In some embodiments, a resource indication value (RIV) in the FDRA of type 1 is determined by replacing N_{BWP}^{size} with N_{equiv}^{size}, RBₛₜₐᵣₜ with Aₛₜₐᵣₜ, and/or L_{RBs} with Aₗₑₙ in a RIV derivation, where N_{BWP}^{size} refers to a size of the BWP, N_{equiv}^{size} refers to a size of equivalent bandwidth after taking the blocking band out, RBₛₜₐᵣₜ refers to a starting RB index, Aₛₜₐᵣₜ refers to an equivalent starting RB index after taking the blocking band out, L_{RBs} refers to a number of contiguously allocated resource blocks, and Aₗₑₙ refers to an equivalent number of allocated RB available for PDSCH after taking the blocking band out.

In some embodiments, N_{equiv}^{size}=N_{BWP}^{size}−N_{DL-BLK}^{size}; Aₛₜₐᵣₜ=RBₛₜₐᵣₜ−N_{DL-BLK}^{size} if RBₛₜₐᵣₜ≥(N_{DL-BLK}^{start}+N_{DL-BLK}^{size}); Aₛₜₐᵣₜ=RBₛₜₐᵣₜ otherwise; Aₗₑₙ=L_{RBs}−N_{DL-BLK}^{size} if RBₛₜₐᵣₜ<N_{DL-BLK}^{start} and (RBₛₜₐᵣₜ+L_{RBs})≥(N_{DL-BLK}^{start}+N_{DL-BLK}^{size}); Aₗₑₙ=L_{RBs} otherwise, where the blocking band starts at RB index N_{DL-BLK}^{start} and contains N_{DL-BLK}^{size} RBs. RBs may be contiguous RBs. The contiguous RBs may be RBs contiguous in frequency domain.

In some embodiments, the RBs in the blocking band are available for the PDSCH allocation. In some embodiments, the signaling provides an indication to indicate whether the RBs allocated by the signaling and located in the blocking band are available for the PDSCH allocation. In some embodiments, the indication provided by the signaling is an one-single bit information field. In some embodiments, the indication provided by the signaling indicates the RBs allocated by the signaling and located in the blocking band are available for the PDSCH allocation if a frequency-domain beginning boundary and/or a frequency-domain ending boundary allocated by the signaling is located in the blocking band. In some embodiments, the indication provided by the signaling indicates the RBs allocated by the signaling and located in the blocking band are not available for the PDSCH allocation if a frequency-domain beginning boundary and/or a frequency-domain ending boundary allocated by the signaling is located outside of in the blocking band.

In some embodiments, the indication provided by the signaling indicates the RBs allocated by the signaling and located in the blocking band are available for the PDSCH allocation if a size L_{RBs} of RB allocation by the signaling satisfies L_{RBs}∉Φ or equivalently L_{RBs}∈Φ̅, where Φ is a pre-defined or configured numerical set of a information allocation size in frequency domain, and Φ̅ is a complementary set of Φ, where L_{RBs} refers to a number of contiguously allocated resource blocks. In some embodiments, the indication provided by the signaling indicates the RBs allocated by the signaling and located in the blocking band are not available for the PDSCH allocation if a size L_{RBs} of RB allocation by the signaling satisfies L_{RBs}∈Φ or equivalently L_{RBs}∉Φ̅, where Φ is a pre-defined or configured numerical set of a information allocation size in frequency domain, and Φ̅ is a complementary set of Φ, where L_{RBs} refers to a number of contiguously allocated resource blocks. In some embodiments, Φ is a set of all RB allocation sizes with even numbers or odd numbers.

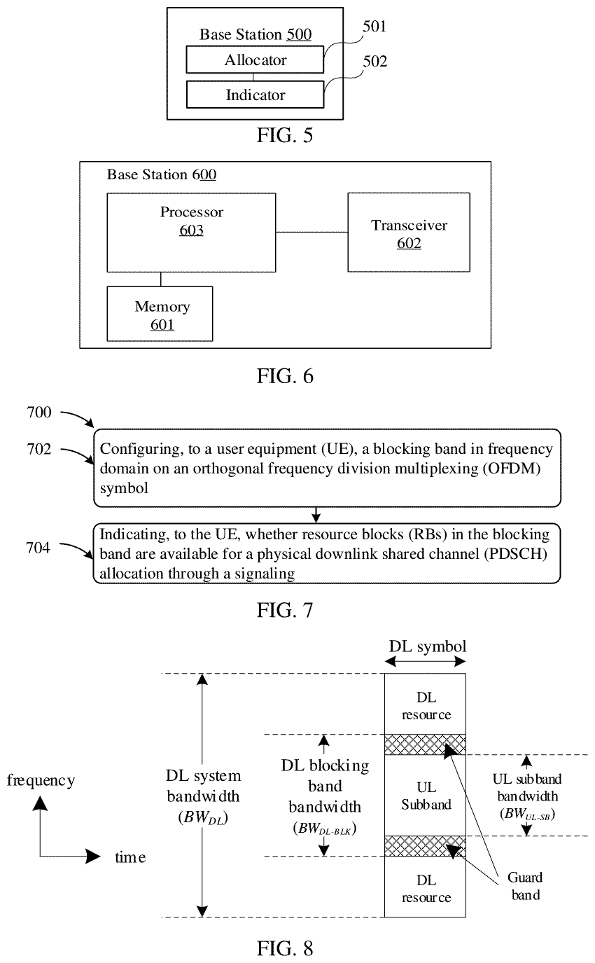

FIG. 5 illustrates an example of a base station 500 according to an embodiment of the present application. The base station 500 is configured to implement some embodiments of the disclosure. Some embodiments of the disclosure may be implemented into the base station 500 using any suitably configured hardware and/or software. The base station 500 includes an allocator 501 configured to configure, to a user equipment (UE), a blocking band in frequency domain on an orthogonal frequency division multiplexing (OFDM) symbol and an indicator 502 configured to indicate, to the UE, whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured. Further, base station 500 is configured to perform at least one of wireless communication methods of resource allocation in some embodiments described herein.

FIG. 6 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art. Further, base station 600 is configured to perform at least one of wireless communication methods of resource allocation in some embodiments described herein.

In some embodiments, the processor 603 my configure to a user equipment (UE), a blocking band in frequency domain on an orthogonal frequency division multiplexing (OFDM) symbol, and the processor 603 my indicate, to the UE, whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured.

FIG. 7 is an example of a wireless communication method 700 of resource allocation performed by a base station according to an embodiment of the present disclosure. The wireless communication method 700 of resource allocation performed by the base station is configured to implement some embodiments of the disclosure. Some embodiments of the disclosure may be implemented into the wireless communication method 700 of resource allocation performed by the base station using any suitably configured hardware and/or software. In some embodiments, the wireless communication method 700 of resource allocation performed by the base station includes: an operation 702, configuring, to a user equipment (UE), a blocking band in frequency domain on an orthogonal frequency division multiplexing (OFDM) symbol, and an operation 704, indicating, to the UE, whether resource blocks (RBs) in the blocking band are available for a physical downlink shared channel (PDSCH) allocation through a signaling. This can solve issues in the prior art and other issues, and/or address issues when a physical downlink shared channel (PDSCH) is scheduled in an orthogonal frequency division multiplexing (OFDM) symbol in which a blocking band is configured.

In some embodiments, the RBs in the blocking band are not available for the PDSCH allocation. In some embodiments, a bit size of a frequency domain resource allocation (FDRA) field in the signaling is determined by not including the RBs in the blocking band into the PDSCH allocation. In some embodiments, the bit size of the FDRA field in the signaling is determined based on a size of the blocking band and a size of a bandwidth part (BWP). In some embodiments, the bit size of FDRA field in the signaling is determined based on a FDRA of type 0, a FDRA of type 1, and/or a dynamic switch between the FDRA of type 0 and the FDRA of type 1.

In some embodiments, the bit size of the FDRA field in the signaling is determined by at least one of the followings:

$${N}_{FDRA , new}^{type 0} = ⌈ \frac{{N}_{BWP}^{size} - {N}_{BLCK}^{size} + ( {N}_{BWP}^{start} mod P )}{P} ⌉$$

for the FDRA of type 0;

$${N}_{FDRA , new}^{type 1} = ⌈ {log}_{2} ( \frac{( {N}_{BWP}^{size} - {N}_{BLCK}^{size} ) \cdot ( {N}_{BWP}^{size} - {N}_{BLCK}^{size} + 1 )}{2} ) ⌉$$

for the FDRA of type 1; or max(N_{FDRA,new}^{type0}, N_{FDRA,new}^{type1})+1 for a dynamic switch between the FDRA of type 0 and the FDRA of type 1, where N_{FDRA,new}^{type0} refers to a new bit size for the FDRA of type 0, N_{BWP}^{size} refers to the size of the BWP, N_{BLCK}^{size} refers to the size of the blocking band, N_{BWP}^{start} refers to a starting position of the BWP, and N_{FDRA,new}^{type1} refers to a new bit field size for the FDRA of type 1.

In some embodiments, bit size determinations apply if and only if at least one of the following conditions is met: N_{FDRA,new}^{type0}<N_{FDRA}^{type0} for the FDRA of type 0; N_{FDRA,new}^{type1}<N_{FDRA}^{type1} for the FDRA of type 1; or max(N_{FDRA,new}^{type0}, N_{FDRA,new}^{type1})<max(N_{FDRA}^{type0}, N_{FDRA}^{type1}) for the dynamic switch between the FDRA of type 0 and the FDRA of type 1, where N_{FDRA,new}^{type0} refers to a new bit size for the FDRA of type 0, N_{FDRA}^{type0} refers to a bit size for the FDRA of type 0, N_{FDRA,new}^{type1} refers to a new bit field size for the FDRA of type 1, and N_{FDRA}^{type1} refers to a bit size for the FDRA of type 1.

In some embodiments, a resource indication value (RIV) in the FDRA of type 1 is determined by replacing N_{BWP}^{size} with N_{equiv}^{size}, RBₛₜₐᵣₜ with Aₛₜₐᵣₜ, and/or L_{RBs} with Aₗₑₙ in a RIV derivation, where N_{BWP}^{size} refers to a size of the BWP, N_{equiv}^{size} refers to a size of equivalent bandwidth after taking the blocking band out, RBₛₜₐᵣₜ refers to a starting RB index, Aₛₜₐᵣₜ refers to an equivalent starting RB index after taking the blocking band out, L_{RBs} refers to a number of contiguously allocated resource blocks, and Aₗₑₙ refers to an equivalent number of allocated RB available for PDSCH after taking the blocking band out.

In some embodiments, N_{equiv}^{size}=N_{BWP}^{size}−N_{DL-BLK}^{size}; Aₛₜₐᵣₜ=RBₛₜₐᵣₜ−N_{DL-BLK}^{size} if RBₛₜₐᵣₜ≥(N_{DL-BLK}^{start}+N_{DL-BLK}^{size}); Aₛₜₐᵣₜ=RBₛₜₐᵣₜ otherwise; Aₗₑₙ=L_{RBs}−N_{DL-BLK}^{size} if RBₛₜₐᵣₜ<N_{DL-BLK}^{start} and (RBₛₜₐᵣₜ+L_{RBs})≥(N_{DL-BLK}^{start}+N_{DL-BLK}^{size}); Aₗₑₙ=L_{RBs} otherwise, where the blocking band starts at RB index N_{DL-BLK}^{start} and contains N_{DL-BLK}^{size} RBs. RBs may be contiguous RBs. The contiguous RBs may be RBs contiguous in frequency domain.

In some embodiments, the RBs in the blocking band are available for the PDSCH allocation. In some embodiments, the signaling provides an indication to indicate whether the RBs allocated by the signaling and located in the blocking band are available for the PDSCH allocation. In some embodiments, the indication provided by the signaling is an one-single bit information field. In some embodiments, the indication provided by the signaling indicates the RBs allocated by the signaling and located in the blocking band are available for the PDSCH allocation if a frequency-domain beginning boundary and/or a frequency-domain ending boundary allocated by the signaling is located in the blocking band. In some embodiments, the indication provided by the signaling indicates the RBs allocated by the signaling and located in the blocking band are not available for the PDSCH allocation if a frequency-domain beginning boundary and/or a frequency-domain ending boundary allocated by the signaling is located outside of in the blocking band.

In some embodiments, the indication provided by the signaling indicates the RBs allocated by the signaling and located in the blocking band are available for the PDSCH allocation if a size L_{RBs} of RB allocation by the signaling satisfies L_{RBs}∉Φ or equivalently L_{RBs}∈Φ̅, where Φ is a pre-defined or configured numerical set of a information allocation size in frequency domain, and Φ̅ is a complementary set of Φ, where L_{RBs} refers to a number of contiguously allocated resource blocks. In some embodiments, the indication provided by the signaling indicates the RBs allocated by the signaling and located in the blocking band are not available for the PDSCH allocation if a size L_{RBs} of RB allocation by the signaling satisfies L_{RBs}∈Φ or equivalently L_{RBs}∉Φ̅, where Φ is a pre-defined or configured numerical set of a information allocation size in frequency domain, and Φ̅ is a complementary set of Φ, where L_{RBs} refers to a number of contiguously allocated resource blocks. In some embodiments, Φ is a set of all RB allocation sizes with even numbers or odd numbers.

### Exemplary Technical Solutions

FIG. 8 illustrates an uplink (UL) subband and downlink (DL) blocking band in a DL symbol configured to implement some embodiments presented herein. FIG. 8 illustrates that, in some embodiments, from base station perspective, if there are both downlink resources and uplink resources in an OFDM symbol, there is a guard band between the neighboring downlink resource and uplink resource, as illustrated in FIG. 8. In other words, if the OFDM resources within the uplink subband are used as uplink resources, the resources that are not available for downlink in the OFDM symbol include resources within the uplink subband and resources within the two guard bands around the uplink subband. From UE perspective, a UE may not need to know the uplink subband configured to another UE as well as the guard bands. What a UE needs to know is just the band of resources that are unavailable to be taken as downlink resources—it is called in some embodiments of the present disclosure the “blocking band”, which is the aggregation of the uplink subband and the surrounding guard bands. As illustrated in FIG. 8, an uplink subband in a DL symbol, protected by the blocking band, and a bandwidth of the blocking band (BW_{DL-BLK}) is not less than a bandwidth of an uplink subband (BW_{UL-SB}). For examples, the bandwidth of the blocking band (BW_{DL-BLK}) is always not less than the bandwidth of uplink subband (BW_{UL-SB}).

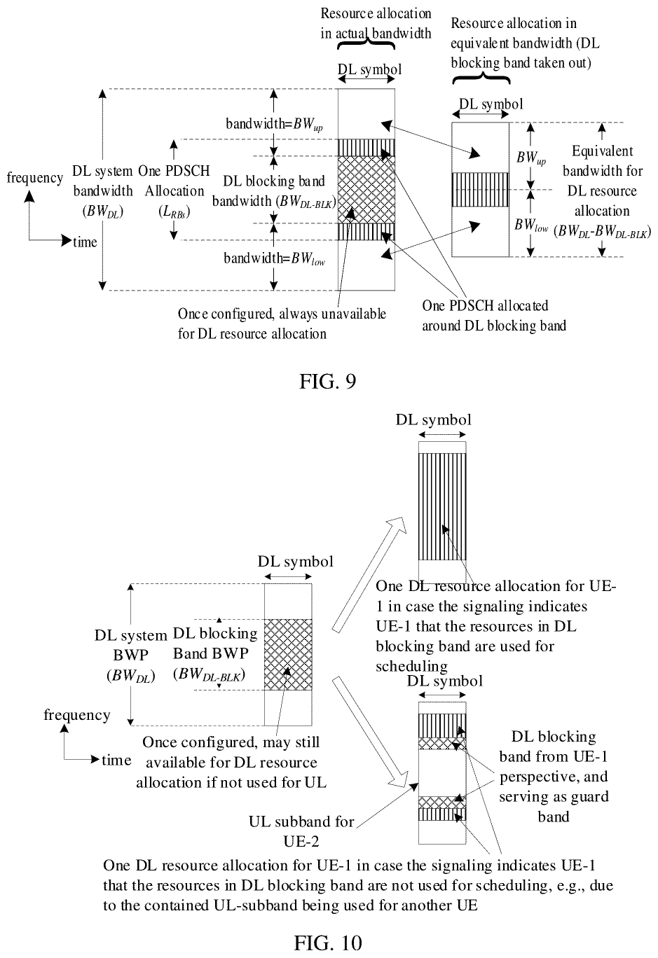

FIG. 9 illustrates a DL resource allocation with a DL blocking band unavailable for DL configured to implement some embodiments presented herein. FIG. 9 illustrates that, in some embodiments, for a UE configured with a blocking band in an OFDM symbol, a downlink scheduling signaling that allocates downlink resources in the symbol for the UE can have following two alternatives:

Alternative-1: Before the UE decodes the downlink scheduling signaling, the UE knows that the resources in the blocking band are not available for the downlink resource allocation, as illustrated in FIG. 9. In other words, the scheduled downlink resources need to skip the resources in the blocking band. For examples, the downlink resource allocation is in a symbol, with blocking band always unavailable for downlink resource allocation.

Alternative-2: FIG. 10 illustrates a DL resource allocation with a DL blocking band either available or unavailable for DL configured to implement some embodiments presented herein. FIG. 10 illustrates that, in some embodiments, before the UE decodes the downlink scheduling signaling, the UE does not know whether the resources in the blocking band is available for the downlink resource allocation or not. As illustrated in FIG. 10, if the uplink subband in the symbol is not used for any UE, there is need to apply the guard band and therefore the resources within the whole blocking band configured to UE-1 are available to the downlink resource allocation scheduled to the UE-1. If the uplink subband in the symbol is used for another UE (UE-2), the guard band is maintained and therefore the resources within the blocking band configured to UE-1 are not available to the downlink resource allocation scheduled to the UE-1.

In Alternative-1, the effective downlink resource bandwidth is, as illustrated FIG. 9, the total downlink bandwidth (BW_{CL}=N_{BWP}^{size}) less the bandwidth of the blocking band (BW_{DL-BLK}), which makes it possible to use smaller number of FDRA field bits in the scheduling signaling. Assume BW_{DL-BLK} equals to N_{BLCK}^{size} in unit of resource block (RB), N_{BWP}^{size} in the existing calculation formula to determine the FDRA field size is replaced with N_{BWP}^{size}N_{BLCK}^{size}. To be more specific, the new FDRA field size is given by at least one of the followings.

For Type-0 only FDRA,

$${N}_{FDRA , new}^{type 0} = ⌈ \frac{{N}_{BWP}^{size} - {N}_{BLCK}^{size} + ( {N}_{BWP}^{start} mod P )}{P} ⌉ .$$

For Type-1 only FDRA,

$${N}_{FDRA , new}^{type 1} = ⌈ {log}_{2} ( \frac{( {N}_{BWP}^{size} - {N}_{BLCK}^{size} ) \cdot ( {N}_{BWP}^{size} - {N}_{BLCK}^{size} + 1 )}{2} ) ⌉ .$$

For dynamic switch between Type-0 FDRA and Type-1 FDRA, max(N_{FDRA,new}^{type0}, N_{FDRA,new}^{type1})+1.

In Alternative-1, the Type-1 FDRA needs to have a new resource indication value (RIV) derivation, corresponding to a starting resource block index (RBₛₜₐᵣₜ) and a length in terms of a number of contiguously allocated resource blocks (L_{RBs}). Note that L_{RBs} is the number of RBs allocated to the UE, which may potentially include the RBs from the blocking band. Assume the blocking band starts at resource block (RB) index N_{DL-BLK}^{start} and contains N_{DL-BLK}^{size} RBs, where N_{DL-BLK}^{start} and N_{DL-BLK}^{size} are equivalent to BW_{low} and BW_{DL-BLK} in FIG. 9 respectively. RBs may be contiguous RBs. The contiguous RBs may be RBs contiguous in frequency domain. Both the starting RB and ending RB of the downlink resource allocation do not fall into blocking band, i.e., both RBₛₜₐᵣₜ and (RBₛₜₐᵣₜ+L_{RBs}) do not fall into [N_{DL-BLK}^{start}, N_{DL-BLK}^{start}+N_{DL-BLK}^{size}), then the new RIV is encoded as following:

Denote:
N_{equiv}^{size} refers to an equivalent bandwidth after taking the DL blocking band out.

$${N}_{equiv}^{size} = {N}_{BWP}^{size} - {N}_{DL - BLK}^{size} .$$

Aₛₜₐᵣₜ refers to an equivalent starting RB index after taking the DL blocking band out.

if RBₛₜₐᵣₜ ≥ (N_{DL-BLK}^{start} + N_{DL-BLK}^{size}) then
Aₛₜₐᵣₜ = RBₛₜₐᵣₜ − N_{DL-BLK}^{size};
else
Aₛₜₐᵣₜ = RBₛₜₐᵣₜ.

Aₗₑₙ refers to an equivalent number of allocated RB available for PDSCH after taking the DL blocking band out.

if RBₛₜₐᵣₜ < N_{DL-BLK}^{start} AND (RBₛₜₐᵣₜ + L_{RBs}) ≥
(N_{DL-BLK}^{start} + N_{DL-BLK}^{size}) then
Aₗₑₙ = L_{RBs} − N_{DL-BLK}^{size};
else
Aₗₑₙ = L_{RBs}.

RIV derivation: use the existing RIV derivation, but replace N_{BWP}^{size} with N_{equiv}^{size}, RBₛₜₐᵣₜ with Aₛₜₐᵣₜ, and L_{RBs} with Aₗₑₙ.

if (Aₗₑₙ − 1) ≤ └N_{equib}^{size}/2┘ then
RIV = N_{equiv}^{size} · (Aₗₑₙ − 1) + Aₛₜₐᵣₜ
else
RIV = N_{equiv}^{size} · (N_{equiv}^{size} − Aₗₑₙ + 1) +
(N_{equiv}^{size} − 1 − Aₛₜₐᵣₜ), where 1 ≤ Aₗₑₙ ≤ N_{equiv}^{size} −
Aₛₜₐᵣₜ.

Correspondingly, in some examples, the RIV received by the UE can be decoded as following:
Step-1: Use the legacy RIV decoding to obtain {Aₛₜₐᵣₜ, Aₗₑₙ} from the received RIV, with N_{BWP}^{size} replaced by N_{equiv}^{size}.
Step-2: Recover {RBₛₜₐᵣₜ, L_{RBs}} from {Aₛₜₐᵣₜ, Aₗₑₙ, N_{DL-BLK}^{start}, N_{DL-BLK}^{size}} as following:

if Aₛₜₐᵣₜ ≥ N_{DL-BLK}^{start} then RBₛₜₐᵣₜ = Aₛₜₐᵣₜ + N_{DL-BLK}^{size};
else RBₛₜₐᵣₜ = Aₛₜₐᵣₜ.
if (Aₛₜₐᵣₜ < N_{DL-BLK}^{start}) AND (Aₛₜₐᵣₜ + Aₗₑₙ ≥ N_{DL-BLK}^{start})
then L_{RBs} = Aₗₑₙ + N_{DL-BLK}^{size},
else L_{RBs} = Aₗₑₙ.

It should be pointed out that, 5G-NR Type-1 downlink resource allocation in some cases can be allocated in unit of K>1 RBs besides the unit of K=1 RBs as assumed in the above

description. For these cases, the above principles and algorithms described in [0063]˜[0073] still apply, with each of parameters from {RBₛₜₐᵣₜ, L_{RBs}, N_{BWP}^{size}, N_{DL-BLK}^{start}, N_{DL-BLK}^{size}} replaced by 1/K of its value.

The above method in Alternative-1 targets to reduce the overhead of FDRA field in scheduling signaling. Then it is meaningful and applicable only when it can indeed reduce the FDRA overhead. Therefore, in some embodiments, the above-mentioned method in Alternative-1 is based on the following condition:
For Type-0 only FDRA, N_{FDRA,new}^{type0}<N_{FDRA}^{type0}.
For Type-1 only FDRA, N_{FDRA,new}^{type1}<N_{FDRA}^{type1}.
For dynamic switch between Type-0 FDRA and Type-1 FDRA, max(N_{FDRA,new}^{type0}, N_{FDRA,new}^{type1})<max(N_{FDRA}^{type0}, N_{FDRA}^{type1}).

In Alternative-2, the downlink scheduling signaling indicates to the scheduled UE whether or not the resources in the configured blocking band can be used as downlink resources for the resource allocation scheduled by this signaling. As illustrated in FIG. 10, if the scheduling signaling indicates yes, the scheduled downlink resources are allocated as if the blocking band does not exist. If the scheduling signaling indicates no, the scheduled downlink resources are allocated as in legacy scheduling scheme, but any allocated downlink resource that falls into the blocking band is not available for the scheduled UE's downlink reception. For examples, the downlink reception of the UE needs to skip the resources in the blocking band configured to the UE.

In Alternative-2, the above-mentioned binary signaling indication can be implemented as either an explicit single-bit information field or an implicit indication. The implicit indication can come from an existing PDSCH-scheduling signaling content/property or a combination of several existing PDSCH-scheduling signaling contents/properties. For example, the signaling property between unicast scheduling and non-unicast scheduling can be used for implicit indication: the configured DL blocking band takes effect for unicast scheduling but not for non-unicast scheduling. Some embodiments of the present disclosure focus on the implicit indication by FDRA field itself. To be more specific, because FDRA field of a PDSCH-scheduling signaling tells two pieces of information: starting/ending boundaries of the PDSCH allocation in frequency domain and the size of PDSCH allocation in frequency domain (e.g., the number of RBs allocated by the signaling for the PDSCH), the implicit indication can be contained in the starting/ending boundaries of the allocation derived from FDRA information or in the size of allocation derived from FDRA information.

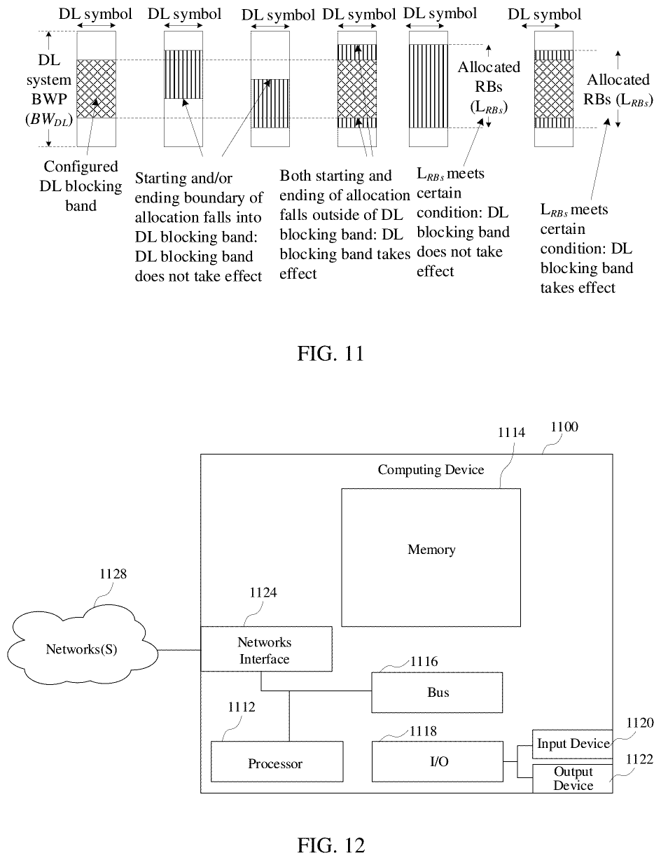

FIG. 11 illustrates indication of whether a DL blocking subband takes effect configured to implement some embodiments presented herein. For examples, FIG. 11 illustrates various implicit indication methods where the PDSCH resource allocation implicitly indicates whether the configured blocking band takes effect (i.e., whether the allocated PDSCH RBs that overlapes with blocking band are not available for PDSCH). FIG. 11 illustrates that, in some embodiments, for the implicit indication based on starting/ending boundaries of the allocation, as illustrated in FIG. 11, because it does not make much sense to have either the starting boundary or ending boundary or both boundaries of a PDSCH allocation falling into DL blocking band when the DL blocking band takes effect given the same allocation effect can be achieved by a different allocation, these kinds of RB allocations for PDSCH (either starting or ending or even both boundaries falling into blocking band) could be used to implicitly indicate that the DL blocking band does not take effect (i.e., the allocated RBs falling into DL blocking band are available for PDSCH). In contrast, if an RB allocation for PDSCH has both starting boundary and ending boundary of the allocation in frequency domain falling outside of DL blocking band, such allocation implicitly indicates that the DL blocking band takes effect (i.e., the allocated RBs falling into DL blocking band are unavailable for PDSCH).

For the implicit indication based on frequency-domain size of the allocation (denoted as L_{RBs}), as illustrated in FIG. 11, the implicit indication can be based on a binary-output function (e.g., a Boolean function) that takes L_{RBs} as an input parameter. Quite some functions qualify this purpose, for example: Whether L_{RBs} (or L_{RBs}/K, where K is mentioned in the above some embodiments is even or odd. More generally, L_{RBs}∈Φ can be an indication for DL blocking band taking effect to the scheduled PDSCH, and L_{RBs}∉Φ for DL blocking subband not taking effect to the scheduled PDSCH, where Φ is a pre-defined or even configured numerical set of PDSCH allocation size in frequency domain.

The implicit indication based on allocation size and the implicit indication based on starting/ending boundaries of the allocation can be combined. For example, if either of the following two conditions is met, the DL blocking band configured for a UE does not take effect for a PDSCH allocation scheduled by the signaling for the same UE; otherwise, the DL block band takes effect for the PDSCH allocation.

Condition-1: Either starting boundary, or ending boundary, or even both boundaries of the PDSCH allocation in frequency domain fall into DL blocking band.

Condition-2: Both starting boundary and ending boundary of the PDSCH allocation in frequency domain fall outside of DL blocking band, and the PDSCH allocation size (L_{RBs}) satisfies L_{RBs}∉Φ or L_{RBs}∈Φ̅, where Φ̅ is the complementary set of Φ.

In implementation, the above described methods and their variations may be implemented as computer software instructions or firmware instructions. Such instructions may be stored in an article with one or more machine-readable storage devices connected to one or more computers or integrated circuits or digital processors such as digital signal processors and microprocessors. In a communication system of 3GPP New-Radio, the FDRA field determination in base station and user equipment and related signal processing may be implemented in form of software instructions or firmware instructions for execution by a processor in the transmitter and receiver or the transmission and reception controller. In operation, the instructions are executed by one or more processors to cause the transmitter and receiver or the transmission and reception controller to perform the described functions and operations. Other variations and enhancements are possible based on what is mentioned here.

In summary, in some embodiments of the present disclosure, in order to support a UL subband in a DL OFDM symbol, a set of contiguous RBs containing the UL subband as well as the guard bands may be potentially reserved as not available to DL resource allocation. Some embodiments of the present disclosure name this set of contiguous RBs as blocking band and can address the issues when a PDSCH is scheduled in an OFDM symbol in which a downlink block band is configured. For example, if the resources in blocking band is specified by specification as unavailable to PDSCH resource allocation, the FDRA field in PDSCH scheduling signaling is improved to use a smaller number of bits to save signaling overhead. For example, the new RIV derivation is also innovated. For example, if the resources in blocking band can be indicated on-the-fly whether to be available to the scheduled PDSCH resource allocation, both explicit indication and implicit indication are provided.

Commercial interests for some embodiments are as follows. 1. Solve issues in the prior art and other issues. 2. Address issues when a physical downlink shared channel (PDSCH) is scheduled in an orthogonal frequency division multiplexing (OFDM) symbol in which a blocking band is configured. 3. Provide a good communication performance. 4. Provide high reliability. 5. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to wireless communication methods and apparatus of resource allocation are considered for standardizing.

FIG. 12 is an example of a computing device 1100 according to an embodiment of the present disclosure. Any suitable computing device can be used for performing the operations described herein. For example, FIG. 12 illustrates an example of the computing device 1100 that can implement some embodiments of FIG. 1 to FIG. 11 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 11. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

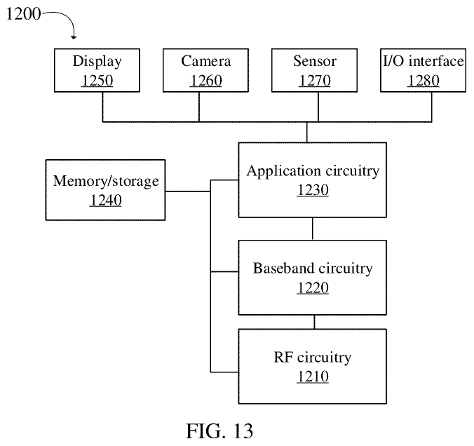

FIG. 13 is a block diagram of an example of a communication system 1200 according to an embodiment of the present disclosure. Embodiments described herein may be implemented into the communication system 1200 using any suitably configured hardware and/or software. FIG. 13 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 11. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 11 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

In various embodiments of the present disclosure, a non-transitory machine-readable storage medium has stored thereon instructions that, when executed by a computer, cause the computer to perform the methods in the embodiments above.

In various embodiments of the present disclosure, a chip includes a processor, configured to call and run a computer program stored in a memory, to cause a device in which the chip is installed to execute the methods in the embodiments above.

In various embodiments of the present disclosure, a computer readable storage medium, in which a computer program is stored, causes a computer to execute the methods in the embodiments above.

In various embodiments of the present disclosure, a computer program product includes a computer program, and the computer program causes a computer to execute the methods in the embodiments above.

In various embodiments of the present disclosure, a computer program causes a computer to execute the methods in the embodiments above.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method of resource allocation performed by a user equipment (UE), comprising:
being configured with a blocking band in frequency domain on an orthogonal frequency division multiplexing (OFDM) symbol; and
determining whether resource blocks (RBs) in the blocking band are available for a physical downlink shared channel (PDSCH) allocation through a signaling.

2. The method of claim 1, wherein the RBs in the blocking band are not available for the PDSCH allocation.

3. The method of claim 1, wherein a bit size of a frequency domain resource allocation (FDRA) field in the signaling is determined by not comprising the RBs in the blocking band into the PDSCH allocation.

4. The method of claim 3, wherein the bit size of FDRA field in the signaling is determined based on a FDRA of type 0, a FDRA of type 1, and/or a dynamic switch between the FDRA of type 0 and the FDRA of type 1.

5. The method of claim 3, wherein the bit size of the FDRA field in the signaling is determined by at least one of the followings:
$${N}_{FDRA , new}^{type 0} = ⌈ \frac{{N}_{BWP}^{size} - {N}_{BLCK}^{size} + ( {N}_{BWP}^{start} mod P )}{P} ⌉$$
for the FDRA of type 0;
$${N}_{FDRA , new}^{type 1} = ⌈ {log}_{2} ( \frac{( {N}_{BWP}^{size} - {N}_{BLCK}^{size} ) \cdot ( {N}_{BWP}^{size} - {N}_{BLCK}^{size} + 1 )}{2} ) ⌉$$
for the FDRA of type 1; or
max(N_{FDRA,new}^{type0}, N_{FDRA,new}^{type1})+1 for a dynamic switch between the FDRA of type 0 and the FDRA of type 1, where N_{FDRA,new}^{type0} refers to a new bit size for the FDRA of type 0, N_{BWP}^{size} refers to the size of the BWP, N_{BLCK}^{size} refers to the size of the blocking band, N_{BWP}^{start} refers to a starting position of the BWP, and N_{FDRA,new}^{type1} refers to a new bit field size for the FDRA of type 1.

6. The method of claim 3, wherein bit size determinations for the FDRA field apply if and only if at least one of the following conditions is met:
N_{FDRA,new}^{type0}<N_{FDRA}^{type0} for the FDRA of type 0;
N_{FDRA,new}^{type1}<N_{FDRA}^{type1} for the FDRA of type 1; or
max(N_{FDRA,new}^{type0}, N_{FDRA,new}^{type1})<max(N_{FDRA}^{type0}, N_{FDRA}^{type1}) for the dynamic switch between the FDRA of type 0 and the FDRA of type 1,
where N_{FDRA,new}^{type0} refers to a new bit size for the FDRA of type 0, N_{FDRA}^{type0} refers to a bit size for the FDRA of type 0, N_{FDRA,new}^{type1} refers to a new bit field size for the FDRA of type 1, and N_{FDRA}^{type1} refers to a bit size for the FDRA of type 1.

7. The method of claim 4, wherein a resource indication value (RIV) in the FDRA of type 1 is determined by replacing N_{BWP}^{size} with N_{equiv}^{size}, RBₛₜₐᵣₜ with Aₛₜₐᵣₜ, and/or L_{RBs} with Aₗₑₙ in a RIV derivation, where N_{BWP}^{size} refers to a size of the BWP, N_{equiv}^{size} refers to a size of equivalent bandwidth after taking the blocking band out, RBₛₜₐᵣₜ refers to a starting RB index, Aₛₜₐᵣₜ refers to an equivalent starting RB index after taking the blocking band out, L_{RBs} refers to a number of contiguously allocated resource blocks, and Aₗₑₙ refers to an equivalent number of allocated RB available for PDSCH after taking the blocking band out.

8. The method of claim 7, wherein:
N_{equiv}^{size}=N_{BWP}^{size}−N_{DL-BLK}^{size};
Aₛₜₐᵣₜ=RBₛₜₐᵣₜ−N_{DL-BLK}^{size} if RBₛₜₐᵣₜ≥(N_{DL-BLK}^{start}+N_{DL-BLK}^{size});
Aₛₜₐᵣₜ=RBₛₜₐᵣₜ otherwise;
Aₗₑₙ=L_{RBs}−N_{DL-BLK}^{size} if RBₛₜₐᵣₜ<N_{DL-BLK}^{start} and (RBₛₜₐᵣₜ+L_{RBs})≥(N_{DL-BLK}^{start}+N_{DL-BLK}^{size});
Aₗₑₙ=L_{RBs} otherwise, where the blocking band starts at RB index N_{DL-BLK}^{start} and contains N_{DL-BLK}^{size} RBs.

9. A user equipment (UE), comprising:
a receiver configured to receive a configuration of a blocking band in frequency domain on an orthogonal frequency division multiplexing (OFDM) symbol; and
a determiner configured to determine whether resource blocks (RBs) in the blocking band are available for a physical downlink shared channel (PDSCH) allocation through a signaling.

10. The UE of claim 9, wherein a bit size of a frequency domain resource allocation (FDRA) field in the signaling is determined by not comprising the RBs in the blocking band into the PDSCH allocation.

11. The UE of claim 10, wherein the bit size of the FDRA field in the signaling is determined based on a size of the blocking band and a size of a bandwidth part (BWP).

12. The UE of claim 9, wherein the RBs in the blocking band are available for the PDSCH allocation.

13. The UE of claim 9, wherein the signaling provides an indication to indicate whether the RBs allocated by the signaling and located in the blocking band are available for the PDSCH allocation.

14. The UE of claim 13, wherein the indication provided by the signaling is an one-single bit information field.

15. The UE of claim 13, wherein at least one of the following applies:
the indication provided by the signaling indicates the RBs allocated by the signaling and located in the blocking band are available for the PDSCH allocation if a frequency-domain beginning boundary and/or a frequency-domain ending boundary allocated by the signaling is located in the blocking band;
the indication provided by the signaling indicates the RBs allocated by the signaling and located in the blocking band are not available for the PDSCH allocation if a frequency-domain beginning boundary and/or a frequency-domain ending boundary allocated by the signaling is located outside of in the blocking band;
the indication provided by the signaling indicates the RBs allocated by the signaling and located in the blocking band are available for the PDSCH allocation if a size L_{RBs} of RB allocation by the signaling satisfies L_{RBs}∉Φ or equivalently L_{RBs}∈Φ̅, where Φ is a pre-defined or configured numerical set of a information allocation size in frequency domain, and Φ̅ is a complementary set of Φ, where L_{RBs} refers to a number of contiguously allocated resource blocks; or
the indication provided by the signaling indicates the RBs allocated by the signaling and located in the blocking band are not available for the PDSCH allocation if a size L_{RBs} of RB allocation by the signaling satisfies L_{RBs}∈Φ or equivalently L_{RBs}∉\tilde{Φ}, where Φ is a pre-defined or configured numerical set of a information allocation size in frequency domain, and Φ̅ is a complementary set of Φ, where L_{RBs} refers to a number of contiguously allocated resource blocks, wherein Φ is a set of all RB allocation sizes with even numbers or odd numbers.

16. A base station, comprising:
an allocator configured to configure, to a user equipment (UE), a blocking band in frequency domain on an orthogonal frequency division multiplexing (OFDM) symbol; and
an indicator configured to indicate, to the UE, whether resource blocks (RBs) in the blocking band are available for a physical downlink shared channel (PDSCH) allocation through a signaling.

17. The base station of claim 16, wherein the RBs in the blocking band are not available for the PDSCH allocation.

18. The base station of claim 16, wherein a bit size of a frequency domain resource allocation (FDRA) field in the signaling is determined by not comprising the RBs in the blocking band into the PDSCH allocation.

19. The base station of claim 18, wherein the bit size of the FDRA field in the signaling is determined based on a size of the blocking band and a size of a bandwidth part (BWP).

20. The base station of claim 18, wherein the bit size of FDRA field in the signaling is determined based on a FDRA of type 0, a FDRA of type 1, and/or a dynamic switch between the FDRA of type 0 and the FDRA of type 1.
